(19) United States
(12) Patent Application Publication
(10) Pub. No.: US 2002/0009194 A1
(43) Pub. Date: Jan. 24, 2002

(54) Cellphone holder

(76) Inventors: Kam Sing Chris Wong, Hong Kong (HK); Ka Lun Alan Wong, Hong Kong (HK); Pui Wah Vincent Ip, Hong Kong (HK); Mika Vanttinen, Salo (FI)

Correspondence Address: PERMAN & GREEN, 425 POST ROAD, FAIRFIELD, CT, 06430, US

(21) Appl. No.: 09/898,630

(22) Filed: Jul. 3, 2001

(30) Foreign Application Priority Data
Jul. 7, 2000 (FI) 20001621

(51) Int. Cl. H04M 1/00

(52) U.S. Cl. 379/449; 379/455

(57) ABSTRACT

The invention relates to a small-sized phone holder (10) to which a phone is attached by means of clamping surfaces (15) which press against the side surfaces of the phone. The said clamping surfaces are made of a soft rubber-like material having a large friction coefficient against the shell material of the phone. The phone is locked in the holder by pushing it lightly against locking surfaces (16) at the bottom (12) of the holder. The locking mechanism in the holder will then turn the clamping surfaces (15) closely against the side surfaces of the phone. The phone is released from the holder by pushing two release buttons (14) whereby the locking mechanism is forced to open and the clamping surfaces which locked the phone in the holder are detached from the side surfaces of the phone.

The invention relates to a cellphone holder comprising a body part and bottom part combined together and, in connection with these, a locking mechanism by means of which a phone can be held in and released from the holder.

A cellphone that is carried along especially in the car needs a holder in which it can be kept. The structure of the holder shall be such that the phone can be easily attached to it and removed from it. It shall be possible to perform all operations on the phone using one hand only. In addition, is shall be possible to use the keypad of the phone without difficulty while the cellphone is in the holder. Therefore, the holder shall be open at least where the phone's keypad and display are located.

A known cellphone holder for car use is disclosed in patent document FI 974183. The solution described therein is basically a cup-like holder. On both sides of the cup-like holder there are locking elements movable within the sides. A cellphone is locked into the holder by applying a turning movement around pivotal bumps on the lower parts of both side walls of the cup-like holder. On both sides of the cellphone there are suitably shaped notches for both the locking elements and pivotal bumps. As the cellphone is turned around the pivotal bumps, the locking elements in the holder catch the notches on the sides of the cellphone. When the turning movement is completed, a mechanical arrangement associated with the locking elements locks the phone in one of its two extreme positions where the phone is locked in the holder. The phone is released from the holder by pressing separate buttons on the sides of the holder which release the locking elements. The phone can then be removed from the holder. The mechanism described in the said document is partly open at the locking elements so that it is susceptible to mechanical damage and dirt. Moreover, each phone size requires a holder of its own. Furthermore, the operation of the holder requires notches in the shell of the phone, which notches are not always desirable from the phone design standpoint.

From patent application EP 0 545 670 A3 we know another variation of cellphone attachment to a cup-like holder by means of a turning movement. Like the holder described above, the holder according to this reference document requires pivotal bumps on the lower parts of the side walls of the holder as well as suitably shaped notches on the sides of the phone to catch the attachment elements on the sides of the holder. In the solution disclosed in the said reference document the shell part comprises two parts one within the other, which parts move relative to each other during the locking action. Each cellphone type/size has to have a holder of its own and there have to be suitable notches on the body of the cellphone for the pivotal bumps and attachment elements. The mechanism facilitating the locking/unlocking action is partly open and therefore susceptible to damage and dirt. In addition the locking mechanism is complex.

From patent application FI 950237 a holder is known by means of which a cellphone can be attached to the holder without using a turning movement. The direction of attachment/detachment of the phone is the direction of the longitudinal axis of the cellphone. This holder, too, is cup-like and it comprises two parts movable with respect to each other along the longitudinal axis of the holder. When a cellphone is attached to the holder, it is first placed in the inner part of the holder, which is movable, in relation to the outer part, to one of two extreme positions. As this is done, locking claws in the outer part become positioned against holes in the inner part. Through the said holes the claws press against attachment notches in the cellphone body. The phone is detached from the holder using separate buttons on the sides of the holder, which make the locking claws retract from the notches in the cellphone body. In this case, too, each cellphone size has to have a holder of its own. Suitably sized notches have to be made in the cellphone body for the locking claws.

U.S. Pat. No. 5,825,874 discloses a holder into which a phone is inserted in a movement along the longitudinal axis of the cellphone. On both sides of the holder there are clamping elements that lock onto notches on the cellphone body. The grip of the said clamping elements on the cellphone body is released by a mechanism comprising a spring, bearing and a pin. When buttons belonging to the said mechanism that project outward from the holder are pushed, the locking mechanism gripping the sides of the cellphone is released and the phone can be removed from the holder. However, the solution disclosed requires that each phone size must have a holder of its own and, furthermore, suitably sized notches have to be made in the cellphone body for the locking element.

From patent application FI 960831 a solution is known in which a cellphone is attached to the holder by both its upper end and its lower end. The holder includes a small recess for the lower end of a cellphone, into which recess the lower end of the cellphone is placed. At the upper end of the holder there is a pivotable locking nose of a kind which in one of its two extreme positions attaches the upper part of the cellphone to the holder, and in the other extreme position lets the phone be removed from the holder. While the solution in the direction of the width of the cellphone allows for the attachment of several different sized phones to the holder, the phone dimensions, however, in the directions of the length and thickness, must not differ from certain set dimensions in order for the attachment to become impossible. In addition, the mechanical implementation of the pivotable locking nose is complex, since the cellphone antenna must be at least partly positioned inside it.

From U.S. Pat. No. 5,694,468 a solution is known which is applicable to cellphones of different sizes in the direction of the width of the phone. The holder comprises an L-shaped body part and two side arms attached thereto. The side arms are movable in the lateral direction with respect to the holder. The side arms are provided with soft gripping surfaces so that there is no need for separate notches in the cellphone body for the gripping elements. The side arms of the holder attach a phone placed in the holder to the holder by means of a spring-cogwheel-lever mechanism included in the holder. When the user wants to place a cellphone into the holder, he presses the release button on the side of the holder. The more the button is pressed, the farther away from each other the side arms travel. When the release button is released, the spring-cogwheel-lever mechanism inside the holder pulls the side arms nearer to each other. This will cause the gripping surfaces to press against the sides of the cellphone. Removal of the phone from the holder is performed by pressing the same release button so that the side arms move outward in the manner described above and the phone can be removed from holder. The mechanical implementation of the holder is complex with the many levers, cogwheels and coil springs. Controlling the movement of the side arms in accordance with the solution described above will not tolerate any disturbances.

An object of this invention is to provide a new type of cellphone holder suitable for different sized cellphones. The shell structure of the phone need not have any notches or projections to secure attachment. In addition, the attachment and removal of the phone can be done with one hand, and while in the holder, the phone is always ready to be used.

The objects of the invention are achieved by a cellphone holder which attaches the cellphone to the holder by exerting pressure against the side surfaces of the cellphone. The attachment surfaces which are pressed against the phone and belong to the locking mechanism are made of elastic material of a fairly high friction so that there is not anymore need to have separate projections or notches in the phone in order to keep the cellphone in place. The cellphone is locked into the holder by pushing it lightly against locking surfaces which are located at the bottom of the holder and belong to the locking mechanism, whereby clamping surfaces on the sides of the holder are pressed against the sides of the phone. At the same time the locking mechanism of the holder is locked in a position in which the phone is held in the holder. The cellphone is released by pushing release buttons on both sides of the holder which open the locking mechanism of the holder.

The cellphone holder according to the invention is characterized in that the locking mechanism comprises two L-shaped locking elements arranged so as to become attached to the cellphone by means of friction between the locking elements and the shell of the cellphone.

The basic idea of the invention is as follows: a cellphone is attached to the holder by means of elastic clamping surfaces pressed against the sides of the phone. The said clamping surfaces form a single entity together with locking surfaces located at the bottom of the holder which move up and down and belong to the locking elements. When these locking surfaces are pushed lightly by the phone, the locking mechanism locks the clamping elements into a position such that the phone is held reliably in the holder by means of the clamping surfaces having a high friction. Locking reliability is ensured by two separate leaf springs which prevent the locking system from becoming unlocked by itself or when an attempt is made to move the phone. The phone is released from the holder by means of release buttons on the both outer sides of the holder. The locking mechanism is forced open by pushing the said buttons. At the same time the force exerted by the leaf spring pushes the locking surfaces of the holder and, hence, the phone, upwards from the holder. The movement of the locking elements simultaneously turns the clamping surfaces outwards and thus brings the clamping surfaces farther away from one another so that the phone can be easily removed from the holder.

An advantage of the invention is that one and the same holder can be used for a plurality of phone models.

Another advantage of the invention is that there is no need to make notches or projections in the cellphone body in order to attach the phone to the holder.

Yet another advantage of the invention is that the holder grips the cellphone body with elastic parts so that the clamping elements in the holder will not scratch the surface of the phone.

Yet another advantage of the invention is that the user of the holder will hear a clear audible sound indicative of both locking and release of the phone.

Yet another advantage of the invention is that the locking mechanism of the holder is mainly located behind the phone, facilitating the manufacture of small-sized holders.

The invention is described in detail in the following. The description refers to the accompanying drawings in which

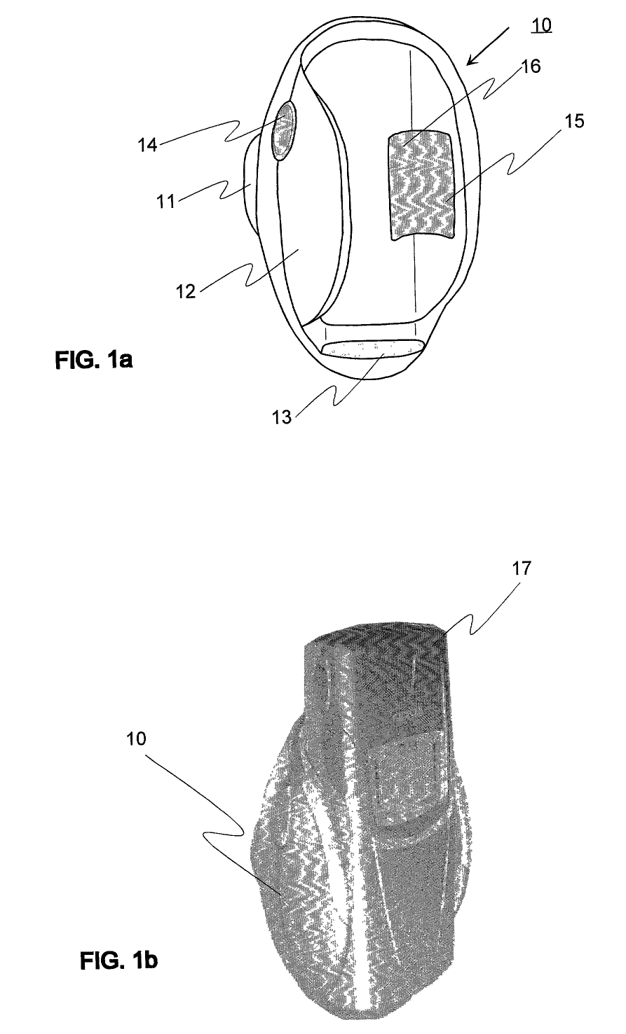

FIG. 1a shows by way of example a cellphone holder according to the invention,

FIG. 1b shows by way of example a holder according to the invention with a cellphone inserted in it,

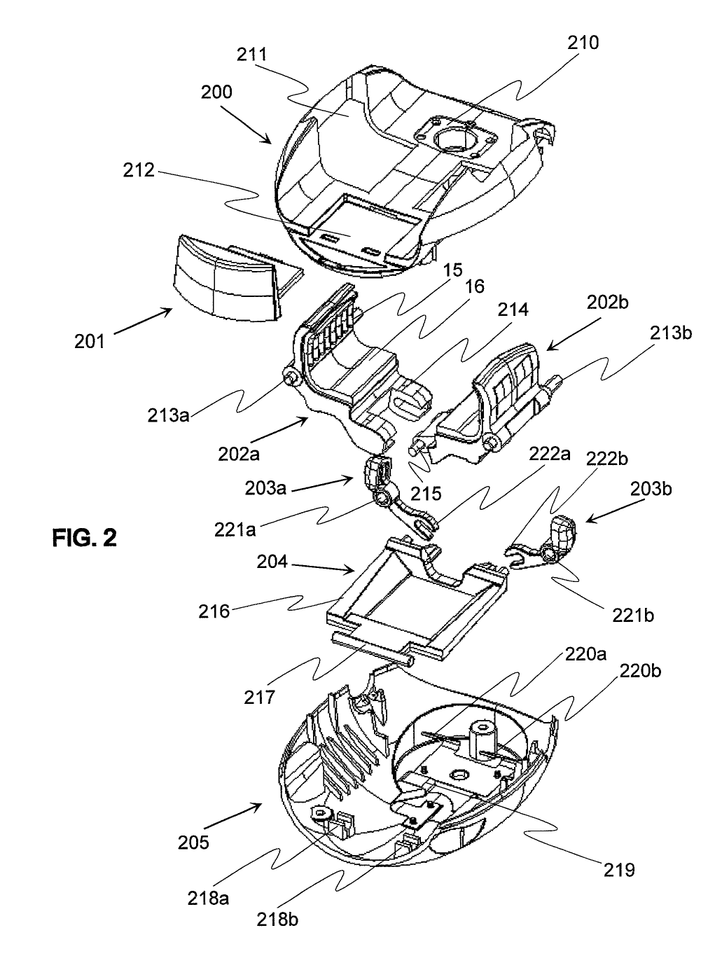

FIG. 2 shows by way of example holder parts in an exploded view,

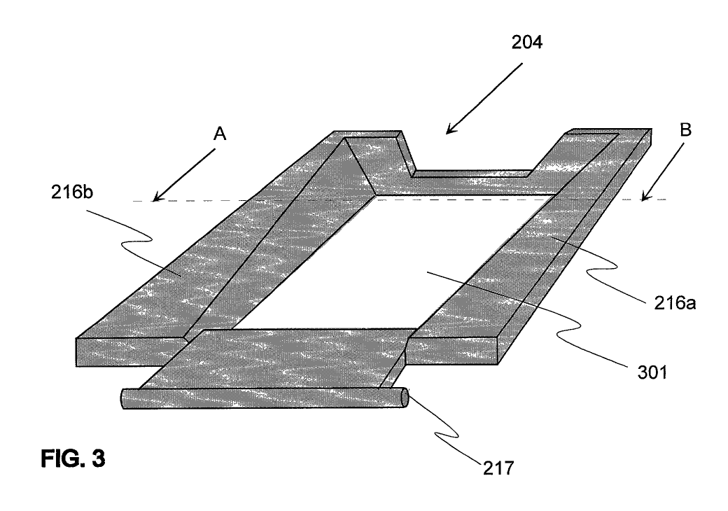

FIG. 3 shows by way of example the locking frame belonging to the holder,

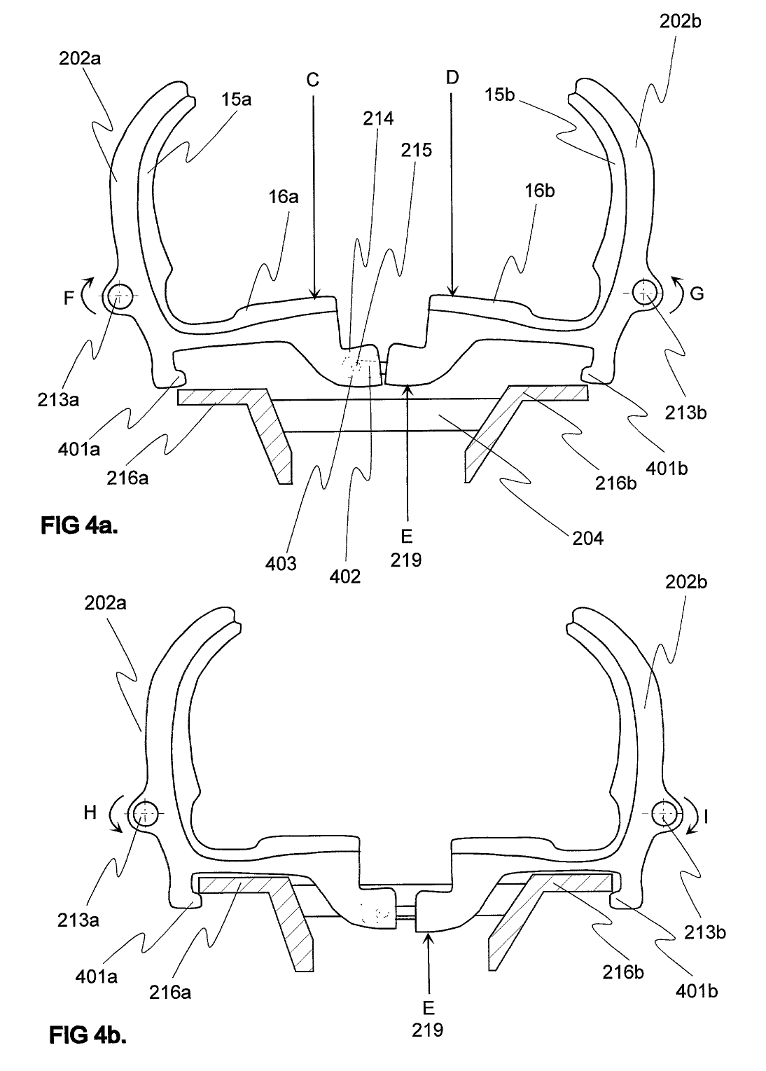

FIG. 4a shows by way of example parts belonging to the locking mechanism of the holder viewed in the direction A-B of FIG. 3 when the locking mechanism is open,

FIG. 4b shows by way of example parts belonging to the locking mechanism of the holder viewed in the direction A-B of FIG. 3 when the locking mechanism is locked,

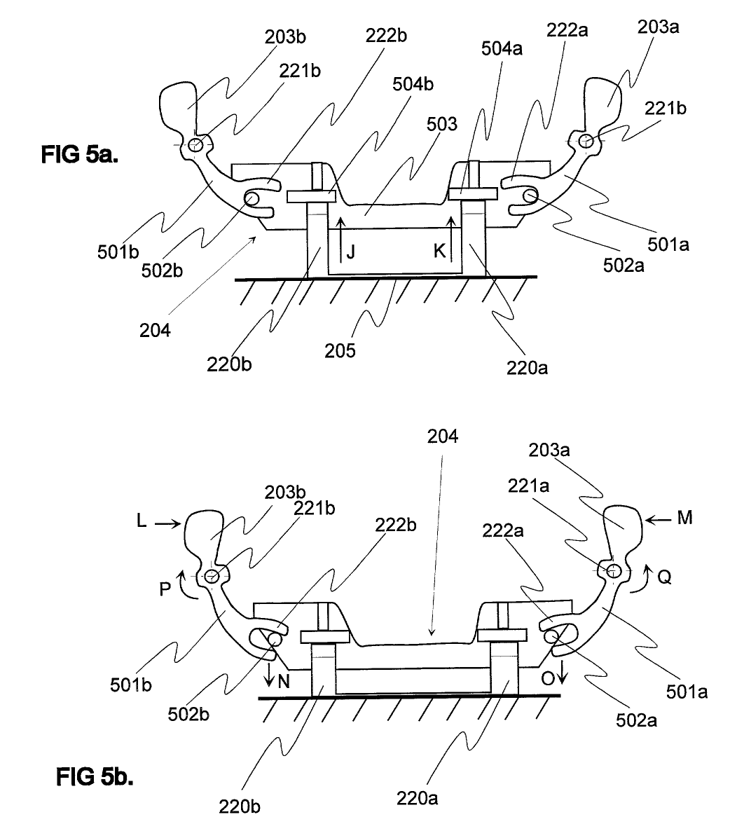

FIG. 5a shows by way of example the position of the locking frame of the holder when the locking mechanism is either open or locked, and

FIG. 5b shows by way of example the position of the locking frame of the holder when the locking mechanism is made open as the phone is removed from the holder.

FIG. 1a shows by way of example the main parts of a phone holder 10 according to the invention. The holder comprises a body part 11, U-shaped bottom part 12, support part 13 attached to the body part, two L-shaped entities which are hereinafter called the locking elements, which include the clamping surfaces 15 and locking surfaces 16 shown in FIG. 1 such that only the right-hand parts are visible, the locking mechanism (not shown) in connection with the locking elements, and two release buttons 14, of which only the leftmost release button is shown in FIG. 1. The locking and clamping surfaces of the locking elements are advantageously made of a soft material of a high friction, such as rubber or thermoplastic material.

The phone is attached to the holder using a turning movement of the L-shaped locking elements. These locking elements are made turnable with respect to the bottom part 12 so that when the phone pushes the locking surfaces 16, the clamping surfaces 15 are pressed against the side surfaces of the phone. At the same time, the movement of the locking surfaces 16 results in the operation of the locking mechanism, described later on, preventing the clamping surfaces 15 from opening by themselves. The phone is released from the holder by pressing two release buttons 14 the movement of which forces the locking mechanism to open in a manner which will be more closely described later on. As the locking mechanism opens, a release spring in the locking mechanism pushes the locking surfaces 16 upwards from the bottom part. At the same time this movement of the locking elements turns the clamping surfaces 15 outwards so that they no more push against the side surfaces of the phone.

In addition, the holder advantageously includes a support part 13 to ensure that the phone will not drop from the holder. The support part 13 may be a fixed part of the body part 11 or bottom part 12 or it may be separately attached to either of those.

FIG. 1b shows by way of example a holder 10 according to the invention into which a cellphone 17 is attached. The keys and display of the cellphone are not concealed by the structures of the holder.

FIG. 2 provides by way of example an exploded view of the structural parts of the cellphone holder according to the invention. The holder comprises the following main parts: bottom part 200, support part 201, locking elements 202a and 202b, release pushers 203a and 203b, locking frame 204 and body part 205. The said parts can be advantageously made of injection-molded plastic material.

The bottom part 200 advantageously includes apertures 211 into which the locking elements 202a and 202b can be fitted so that the locking element movement according to the invention is possible. The bottom part 200 farther includes a fast-attachment part 210 for attaching the whole holder to the desired location. The said fast-attachment part can be advantageously used to adjust the angle of the holder in the plane of the surface of the attachment point. A separate support part 201 can be advantageously attached to the bottom part 200. The attachment may be realized using various snap-on clips designed for the parts in question or glue or a mechanical attachment means.

The holder according to the invention comprises two locking elements 202a and 202b. A locking element is basically L-shaped. Advantageously the locking elements 202a and 202b are mainly symmetrical mirror images of one another. Parts that are symmetrical mirror images in both locking elements include the locking surfaces 16, clamping surfaces 15 and two guide pins, of which guide pins 213a and 213b are shown in the figure. Both locking elements have two guide pins located on the both sides of the locking element in such a manner that the locking element is pivotable on the said guide pins. The bushings 221a and 221b of the release pushers 203a and 203b belonging to the locking mechanism according to the invention use two of these four guide pins as their axles. In addition, the locking element 202a includes two guide brackets 214 that guide the turning movement of the locking element. Both guide brackets 214 of the locking element 202a have got U-shaped guide grooves on their inner surfaces. The guide bracket of the locking element 202b includes two slide pins 215 adapted so as to move in the guide grooves in the guide brackets 214 of the other locking element 202a.

The structure of the release pushers 203a and 203b in the locking mechanism according to the invention comprises, in addition to the buttons 14 shown in FIG. 1 which are located at a first end of the release pushers, also bushings 221a and 221b into which the guide pins belonging to the locking elements 202a, 202b can be inserted. At the other ends of the release pushers there are horseshoe-shaped forks 222a, 222b. Pins 502a and 502b, which are shown in FIGS. 5a and 5b and belong to the locking frame 204, can be fitted in the said forks.

The locking frame 204 is open in the middle. It comprises two substantially parallel edge parts 216. The edge parts are combined at a first end by a planar part substantially parallel with the horizontal plane of the edge parts, which planar part has a swing axle 217 in connection with it. At the second end, the edge parts are joined by an end wall 503, shown more closely in FIG. 5a, which end wall has two pins 502a and 502b as well as two leaf spring counterparts 504a and 504b in connection with it. The guided movement of the second end of the locking frame 204 using the swing axle as its fulcrum is an essential part of the operation of the locking mechanism, which will be described more closely at a later point.

The above-mentioned parts are connected with the body part 205. The body part comprises sockets 218a and 218b for the swing axle 217. A release spring 219 is also attached to the body part so that the free end of the said spring exerts a force on the locking elements 202a and 202b. Two leaf springs 220a, 220b are needed to guide the turning movement of the locking frame 204, and the free ends of the said leaf springs push against the leaf spring counterparts 504a and 504b of the locking frame.

FIG. 3 shows more closely the locking frame 204. The aperture 301 in the locking frame 204 is big enough for the guide brackets of the locking elements 202a, 202b to move through the said aperture 301. The parts shown in FIG. 3, which are essential to the locking mechanism, comprise the planar edge parts 216a and 216b of the locking frame, in the direction determined by the locking elements 202a and 202b. Operation of the locking frame together with the locking elements in order to achieve a locked state is described more closely in conjunction with the description of FIGS. 4a, 4b, 5a and 5b.

FIGS. 4a and 4b illustrate the operation of the locking mechanism with the help of a cross section viewed in the direction A-B of FIG. 3. In the exemplary situation of FIG. 4a a phone is being inserted in the holder. The locking mechanism comprises the locking elements 202a and 202b, their soft clamping surfaces 15a and 15b and soft locking surfaces 16a and 16b, guide pins 213a and 213b, locking claws 401a and 401b, locking frame 204 and therein especially the planar edge parts 216a and 216b, guide brackets 214 with their guide grooves 403, and slide pins 215 with supporting arms 402. The release spring 219 exerts force all the time on the locking mechanism from the direction indicated by arrow E. By the force of the spring the locking elements 202a and 202b attempt to pivot on guide pins 213a and 213b so that the clamping surfaces move farther away from each other. The maximum limit of this movement is determined by the side walls of the bottom part 200 shown in FIG. 2.

In FIG. 4a, arrows C and D represent forces resulting from the insertion of the phone in the holder. The said forces cause the locking elements 202a and 202b to pivot around the guide pins 213a and 213b in the direction indicated by arrows F and G. This pivoting moves the locking claws 401a and 401b away from each other. FIGS. 4a and 4b exaggerate the size of the locking claws in the plane of the drawing so as to better illustrate their function. The width of the locking claws may vary in the direction of the width of the locking elements 202a and 202b. Advantageously the width of a locking claw is substantially smaller than the width of the locking element itself. When the locking claws have separated far enough, the edge parts 216a and 216b of the locking frame 204 can rise past the locking claws 401a and 401b toward the locking elements 202a and 202b. At the second end of the said locking frame the leaf springs 220a and 220b, which are all the time loading the locking frame 204 at its second end, cause an upward movement, which at the first end of the locking frame is seen as a pivotal movement around the swing axle 217. When the effect of forces C and D ceases as the insertion of the phone in the holder is completed, the force exerted by the release spring 219 in the direction of arrow E attempts to open the locking elements 202a and 202b by turning them in directions H and I shown in FIG. 4b. The edge parts 216a and 216b of the locking frame are then pushed against the bottom of the locking elements 202a and 202b, whereby the locking claws 401a and 401b turn in a sharp movement inwards, toward one another, and catch the edge parts 216a and 216b, as shown in FIG. 4b. At the same time the locking mechanism produces a clicking sound whereby the user knows that the phone is now locked in the holder. In the situation illustrated in FIG. 4b the phone is locked in the the holder. Releasing of the phone from the holder requires a downward movement of the locking frame 204 which can be accomplished in the manner depicted in FIGS. 5a and 5b.

The position of the locking frame 204 which is shown in FIG. 5a as viewed from the second end thereof, is possible in two cases: either when a phone is attached in the holder or when the holder is empty. In the case depicted by FIG. 5a the leaf springs 220a and 220b attached to the body part 205 exert a force in the direction of arrows J and K by pushing against counterparts 504a and 504b attached to the end wall 503 of the locking frame 204. The upward movement of the locking frame 204 is limited by two situations. In the first situation a phone is in the holder and the locking frame 204 touches the bottom of the locking elements 202a and 202b whereby upward movement is not possible. In the second possible situation according to FIG. 5a there is no phone in the holder, in which case the upward movement of the locking frame 204 is prevented by the locking elements 202a, 202b turned to one of their two extreme positions. In that position they touch the body part 205. In that case, the pins 502a and 502b of the locking frame, while in forks 222a and 222b, prevent the movement of the locking frame from continuing upwards.

The exemplary situation of FIG. 5b represents the removal of the phone from the holder. The removal of the phone is started by pressing the release pushers 203a and 203b in the direction indicated by arrows L and M. As a consequence, the arms 501a and 501b of the release pushers move in the direction of arrows N and O and at the same time the release pushers pivot on the guide pins 221a and 221b in the direction indicated by arrows P and Q. The second end of the locking frame 204 thereby moves according to arrows N and O toward the bottom of the body part 205. At the first end of the locking frame the swing axle 217 pivots on the sockets 218a and 218b. This downward movement N, O pushes the locking claws 401a and 401b shown in FIG. 4b downward. The movement of the locking claws forces the locking elements 202a and 202b to pivot on the guide pins 213a and 213b in the direction of arrows G and F. When this movement has opened the distance between the locking claws 401a and 401b so great that the edge parts 216a and 216b of the locking frame 204 can move therebetween, the locking claws 401 a and 402b let the locking frame 204 pass. When the edge parts 216a and 216b of the locking frame have passed the locking claws by, the release spring 219 is free to swiftly turn the locking elements around the locking pins 213a and 213b in the direction indicated by arrows H and I. Consequently, the locking elements 202a and 202b are completely opened. The clamping surfaces 15a and 15b become detached from the phone, bringing us back to the initial situation depicted in FIG. 4a in which there is no phone attached to the holder. The movement of the locking claws makes the locking mechanism produce a clicking sound indicating to the user that the phone has been released.

Using the holder according to the invention, one and the same holder can advantageously provide for phones the widths of which advantageously vary between 41 to 45 mm, for example. The weight of the phone may be around 150 g at the most. The locking mechanism action according to the invention can be achieved when the locking elements are able to turn about 10° in the holder. The hardness of the advantageously rubber-like material of the clamping surface and guide surface is of the order of Shore A 35. The holding force of the holder according to the invention is of the order of 7 N. The insertion force required for locking the phone is of the order of 3 N. Removal of a phone locked in the holder requires a force of the order of 10 N.

Above it was described some advantageous embodiments of the invention. The invention is not limited solely to those exemplary embodiments. For example, the outer dimensions of phones may deviate from the advantageous embodiment described above. Similarly, there may be just one movable locking and clamping surface and locking element needed for the attachment of the phone, instead of the two presented in the advantageous embodiment above. In addition, the inventional idea may be applied in many ways within the scope defined by the claims attached hereto.

1. A cellphone holder comprising a body part and bottom part combined together and in association therewith a locking mechanism by means of which a phone can be held in and released from the holder, the locking mechanism comprising two L-shaped locking elements adapted so as to become attached to a cellphone by means of friction between the locking elements and the shell of the cellphone.

2. A holder according to claim 1 wherein the L-shaped locking elements comprise clamping surfaces, locking surfaces and two guide pins.

3. A holder according to claim 2 wherein the clamping surfaces and locking surfaces of the locking elements are made of rubber or thermoplastic material.

4. A holder according to claim 2 wherein the locking mechanism comprises in addition to the locking elements coupled together movably in relation to each other, two release pushers the bushings in which are fitted onto the guide pins in the locking elements, and a locking frame adapted so as to be movable under the locking elements.

5. A holder according to claim 4 wherein the locking elements comprise locking claws adapted so as to catch the locking frame in order to achieve locked state.

6. A holder according to claim 5 wherein the length of the locking claws in the locking elements is only a fraction of the total length of the locking elements.

7. A holder according to claim 4 wherein the release pusher comprises, in addition to the button 14 located at its first end, an arm portion, a bushing in the arm portion and a horseshoe-shaped fork at the other end of the arm portion.

8. A holder according to claim 4 wherein the locking frame comprises two substantially parallel edge parts combined at a first end by a planar part in combination with a swing axle, and combined at a second end by an end wall which includes two pins and two leaf spring counterparts.

9. A holder according to claim 1 wherein the body part includes two sockets, a release spring adapted so as to exert force on the locking elements, and two leaf springs adapted so as to exert force on the leaf spring counterparts in the locking frame in order to control the operation of the locking mechanism.

10. The use of a holder according to the claim 1 for attaching a cellphone to an object.
